(19) United States
(12) Patent Application Publication
(10) Pub. No.: US 2007/0114775 A1
(43) Pub. Date: May 24, 2007

(54) Seat belt apparatus

(75) Inventors: Koji Inuzuka, Tokyo (JP); Koji Tanaka, Tokyo (JP); Masato Takao, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/601,772

(22) Filed: Nov. 20, 2006

(30) Foreign Application Priority Data
Nov. 24, 2005 (JP) 2005-338776

(51) Int. Cl. B60R 22/34; B60R 21/00; B65H 75/48

(52) U.S. Cl. 280/807; 242/390.1; 180/268

(57) ABSTRACT

The disclosed seat belt retractor and seat belt apparatus may provide a seat belt storage winding action for storing a seat belt which is effective for conducting the seat belt storage control without making a vehicle occupant feel uncomfortable. The seat belt retractor and apparatus may comprise an electric motor; a spool for winding a seat belt for occupant restraint in association with the driving of the electric motor; and a controller for controlling the driving of the electric motor.

### BACKGROUND

The present invention relates to a technology for storing a seat belt for occupant restraint, which is installed in a vehicle, using an electric motor.

Conventionally, a seat belt apparatus designed for protecting a vehicle occupant by a seat belt is known for restraining the vehicle occupant. For example, the Japanese translation of the PCT international application No. 2003-507252 (incorporated by reference herein) discloses a seat belt apparatus having a seat belt retractor with such a structure such that a spool is driven to rotate by an electric motor so as to wind or unwind a seat belt.

The Japanese translation of the PCT international application No. 2003-507252 discloses a seat belt retractor for a vehicle in which the action of winding the seat belt onto the spool is conducted by the electric motor. However, when this structure is used for the action for winding up a seat belt for the purpose of preventing the seat belt from being kept in a unwound state, that is, “the seat belt storage winding action,” the action of winding up the seat belt onto the spool is required to be conducted smoothly according to the control for the electric motor. Specifically, during the seat belt storage winding action, the seat belt may be caught on a vehicle occupant or a vehicle seat or the seat belt may be withdrawn by the vehicle occupant. To cope with these situations, the seat belt storage winding action is temporarily stopped when the load of the seat belt is increased during the seat belt storage winding action, and the stoppage is continued until the cause of the increasing load is removed. After a predetermined period of time, the seat belt storage winding action is restarted. This operation may be repeated.

However, when the number of times that the seat belt storage winding action (i.e., the driving of the electric motor) is temporarily stopped reaches a specified number because of the stoppage due to increased loading, incomplete storage of the seat belt may occur. In such a case, a vehicle occupant who notices that the storage of the seat belt is incomplete can hardly judge whether the cause of this condition is the termination of the seat belt storage control or a failure of the seat belt apparatus, and thus the vehicle occupant is made to feel uncomfortable. To address the complete storage of the seatbelt, an exclusive detection sensor may be employed to detect how much the seatbelt is stored and completing the storage of the seat belt based on the detected information. Employing the detection sensor, however, requires an additional detection sensor and control system, thus increasing costs.

An object of a disclosed exemplary embodiment is to provide a technology which relates to a seat belt storage winding action for storing a seat belt for occupant restraint, installed in a vehicle, by using an electric motor and which is effective for conducting the seat belt storage control without making a vehicle occupant feel uncomfortable.

The disclosed embodiments may be adapted to a seat belt retractor or a seat belt apparatus to be installed in an automobile. In addition, the disclosed exemplary embodiments may be adapted to a technology for developing a seat belt retractor or a seat belt apparatus to be installed in a vehicle other than automobile, such as an aircraft, a boat, a train, and a bus.

### SUMMARY

A first exemplary disclosed embodiment is a seat belt retractor, which is a device to be installed in a vehicle and may comprise at least an electric motor, a spool, and a controller.

The spool may be a member which is operated in association with the driving of the electric motor to at least wind up a seat belt for occupant restraint. The seat belt capable of being wound onto and unwound from the spool may be a long belt to be worn by a vehicle occupant seated in a seat, and is sometimes called “webbing.” Typically, the vehicle occupant seated in the vehicle seat is restrained by the seat belt when restraint is required, such as during a vehicle collision. In the present embodiment, if required, a power transmission mechanism may be suitably disposed between the electric motor and the spool to selectively achieve a connected state where the electric motor and the spool are connected and a disconnected state where the connected state is cancelled. Also in the present embodiment, the seat belt winding action by the spool may be conducted only by the driving force of the electric motor or by the winding force of an elastic member, such as a return spring acting on the spool, with the driving force of the electric motor as a secondary force.

The controller may be structured at least as a means for controlling the driving of the electric motor. The controller may typically comprise a CPU (central processing unit), an input/output unit, a storage unit, a peripheral unit, and the like. As for the control of the driving of the electric motor, the controller may include various parameters, such as the operation or stoppage time period of the electric motor, and the value or the supplying time period of voltage and/or current to be supplied to the electric motor. Therefore, the driving direction, the driving time, the driving force, and the like of the electric motor may be varied. The controller may be provided exclusively for the seat belt retractor or may also be used for controlling the driving system and/or the electric system of the vehicle.

Further, the controller may activate the electric motor to rotate the spool to wind up the seat belt when a condition for starting the seat belt storage control is satisfied. This winding up operation enables an action for winding up the seat belt onto the spool so as to prevent the seat belt from being kept in the unwound state from the spool. The winding up action is called the “seat belt storage winding action.” With regard to satisfying the condition for starting the seat belt storage control, the condition for starting the seat belt storage control is satisfied when the seat belt is changed from the worn state to the wearing-cancelled state relative to the vehicle occupant or when it is detected that the seat belt is in the wearing-cancelled state relative to the vehicle occupant. The determination of the satisfaction of the condition for starting the seat belt storage control may be made according to the open/closed state of the vehicle door corresponding to the seat belt in addition to the state of the seat belt.

During the seat belt storage control, the seat belt may be caught on a vehicle occupant or a vehicle seat or the seat belt may be withdrawn by the vehicle occupant. For these situations, the controller may temporarily stop the driving of the electric motor during the seat belt storage winding action when the seat belt load acting on the seat belt reaches a predetermined load due to the seat belt being caught on the vehicle occupant or the vehicle seat or due to the seat belt withdrawing operation by the vehicle occupant during the driving of the electric motor. After conducting this control once or a plurality of times, the controller terminates the seat belt storage control. The seat belt load may be obtained by detecting the current value of the electric motor. The number of times of repeating the seat belt winding action, i.e. the number of times of activating and stopping the electric motor, typically depends on the relation between the number of times that the seat belt load reaches the predetermined load and the predetermined maximum number of stopping times. Specifically, in case that the maximum number of times conducting the seat belt winding action is set to three (i.e., the maximum number of stopping times is set three), when the number of times that the seat belt load reaches the predetermined load is between one and three, the seat belt winding action is carried out the corresponding number of times. When the third seat belt winding action is carried out, the seat belt storage control itself is terminated. It should be understood that when the seat belt load does not once reach the predetermined load, only the first seat belt winding action is carried out till the seat belt storage control is terminated.

However, the aforementioned seat belt storage control may cause incomplete storage of the seat belt even after the seat belt winding action, i.e. the action of temporarily stopping the driving of the motor, is repeated the maximum number of times (for example three times). In this case, a vehicle occupant who notices the storage of the seat belt is incomplete cannot judge whether the cause of this phenomenon is the termination of the seat belt storage control or a failure of the seat belt apparatus, and thus the vehicle occupant is made to feel uncomfortable and/or uneasy.

To address this uncomfortable feeling or uneasiness, the controller may be adapted to output a driving signal to an operation device at the termination of the seat belt storage control to activate the operation device so as to inform the vehicle occupant of the termination of the seat belt storage control. The “operation device” may include devices operable to output information to the vehicle occupant. Examples may include an operation device activated by the driving signal from the controller to output sounds or displays, an operation device activated by the driving signal from the controller to carry out a mechanical action, and the like. Specifically, the operation device may be a device having an audio output function outputting voice, buzz or the like; a device having an indication function outputting characters, figures, images or the like; a device for impressing the vehicle occupant on the operation of a movable member; a device having a function of applying pressure, drawing force, or causing vibration to the vehicle occupant, or a combination of two or more of the above devices. The timing for informing the vehicle occupant of the termination of the seat belt storage control may be after the termination of the final seat belt winding action, during the final seat belt winding action, or just before the final seat belt winding action. The operation device may be a component of the seat belt retractor along with the electric motor, the spool, and the controller.

According to the first embodiment of the seat belt retractor, the vehicle occupant may be informed of the termination of the seat belt storage control through the operation device regardless of whether the storage is complete (i.e., the seat belt is fully wound onto the spool) or incomplete (i.e., the seat belt is not fully wound onto the spool). Accordingly, even when the motor is stopped before the seat belt is fully wound onto the spool, the vehicle occupant may notice that the cause is the termination of the seat belt storage control and not a failure of the seat belt apparatus.

Therefore, the seat belt retractor may have a structure capable of storing a seat belt by driving an electric motor and may conduct the seat belt storage control without making the vehicle occupant feel uncomfortable and/or uneasy. According to the present embodiment, there is no need to employ a detection sensor to detect how much the seat belt is stored, thereby keeping the costs of the seat belt retractor low.

A second disclosed exemplary embodiment may be a seat belt retractor comprising an electric motor, a spool, and a seat belt. The controller outputs a control signal to the electric motor for an operation mode different from that for the seat belt storage control. Thus, the vehicle occupant is informed of the termination of the seat belt storage control by the action of winding the seat belt onto the spool according to the control signal. That is, the notification of the termination of the seat belt storage control is conducted by the action of winding up the seat belt. In this arrangement, the electric motor is controlled differently from the normal seat belt storage control so that the action of winding up the seat belt is performed differently from the seat belt storage control. The notification of the termination of the seat belt storage control may be conducted by controlling the electric motor to repeat an action of winding up the seat belt a plurality of times intermittently within a short period of time or by controlling the electric motor with a voltage and/or a current and supplying a time period for the voltage and/or current which are different from those of the normal seat belt storage control.

According to the aforementioned arrangement of the seat belt retractor, the vehicle occupant may recognize that a pulling action different from that of the normal seat belt storage control is applied to the seat belt so as to allow the vehicle occupant to be securely informed of the termination of the seat belt storage control without making the vehicle occupant feel uncomfortable. Preferably, the winding action of the seat belt may be used for informing the vehicle occupant of the termination of the storage control, thereby rationalizing the action of the seat belt retractor.

A third disclosed exemplary embodiment is a seat belt apparatus to be installed in a vehicle. The seat belt apparatus may comprise at least a seat belt for occupant restraint, an electric motor, a spool, a controller, a seat belt buckle, a tongue, a buckle detection sensor, a current detection sensor, and an operation device.

The seat belt may be a long belt to be worn by a vehicle occupant seated in a seat. Typically, the vehicle occupant seated in the vehicle seat may be restrained by the seat belt when restraint is required such as during a vehicle collision. The seat belt buckle may be a member fixed to a vehicle body. The tongue may be a member which is attached to the seat belt and is latched to the seat belt buckle when the seat belt is worn by the vehicle occupant. The buckle detection sensor may detect that the tongue is latched to the seat belt buckle. The current detection sensor may detect a current value of the electric motor. The electric motor and the spool may have substantially the same functions as those of the seat belt retractor of the first embodiment.

When the cancellation of the wearing of the seat belt relative to the vehicle occupant is detected based on the information detected by the buckle detection sensor, the controller may determine that a condition for starting a seat belt storage control is satisfied, and thus activates the electric motor to rotate the spool to wind up the seat belt. The controller may perform a control so as to temporarily stop the driving of the electric motor when the current value of the electric motor detected by the current detection sensor reaches a predetermined reference value during the driving of the electric motor. After the control is conducted once or a plurality of times, the controller terminates the seat belt storage control. That is, when the current value of the electric motor reaches the reference value, it is determined that the seat belt is caught on the vehicle occupant or the vehicle seat or that the seat belt being withdrawn by the vehicle occupant so that the seat belt load acting on the seat belt is increased. In addition, the controller may output a driving signal to an operation device at the termination of the seat belt storage control. The operation device may operate according to the driving signal from the controller, thereby informing the vehicle occupant of the termination of the seat belt storage control. The controller and the operation device of the present embodiment may exhibit substantially the same works and effects as those of the controller and the operation device of the first embodiment.

According to the third embodiment, the vehicle occupant may be informed of the termination of the seat belt storage control through the operation device regardless of whether the storage is complete (i.e., the seat belt is fully wound onto the spool) or incomplete (i.e., the seat belt is not fully wound onto the spool). Accordingly, even when the motor is stopped before the seat belt is fully wound onto the spool, the vehicle occupant may notice that the cause is the termination of the seat belt storage control and not a failure of the seat belt apparatus.

Therefore, the seat belt apparatus of the third embodiment has a structure capable of storing a seat belt by driving an electric motor and may conduct the seat belt storage winding action without making the vehicle occupant feel uncomfortable and/or uneasy. There is no need to employ a detection sensor to detect how much the seat belt is stored, thereby keeping the costs of the seat belt apparatus low.

A fourth disclosed exemplary embodiment is a seat belt apparatus comprising an electric motor, a spool, and a seat belt. The controller may output a control signal to the electric motor for an operation mode different from that for the seat belt storage control, thus informing the vehicle occupant of the termination of the seat belt storage control by the action of winding the seat belt onto the spool according to the control signal. The controller and the operation device of the present embodiment may exhibit substantially the same works and effects as those of the controller and the operation device of the third embodiment.

According to the fourth embodiment, the vehicle occupant may recognize that a pulling action different from that of the normal seat belt storage control is applied to the seat belt so as to allow the vehicle occupant to be securely informed of the termination of the seat belt storage control. Preferably, the winding action of the seat belt may be used for informing the vehicle occupant of the termination of the storage control, thereby rationalizing the action of the seat belt apparatus.

A fifth disclosed exemplary embodiment is a vehicle with a seat belt apparatus. The vehicle may comprise at least a seat belt apparatus such as the third or fourth embodiment and a vehicle seat in which a vehicle occupant is seated. The “vehicle seat” may include a driver seat in which a driver is seated, a front passenger seat, and a rear seat located behind the driver seat and the front passenger seat. The controller of the seat belt apparatus may be adapted to detect the cancellation of the wearing of the seat belt when the tongue latched to the seat belt buckle is released from the seat belt buckle by the vehicle occupant seated in the vehicle seat. In the vehicle of the present embodiment, all or a part of the components of the seat belt apparatus may be accommodated in an accommodating space in the vehicle such as an accommodating space in a pillar, an accommodating space in a seat, or an accommodating space in another part of the vehicle.

According to the fifth embodiment, a vehicle may be provided with a seat belt apparatus which is capable of conducting the seat belt storage winding action using an electric motor without making a vehicle occupant feel uncomfortable and/or uneasy.

As mentioned above, exemplary embodiments of the present invention may relate to a seat belt storage control for storing a seat belt for occupant restraint which is installed in a vehicle by driving of an electric motor. A structure may be employed for outputting a driving signal to an operation device at the termination of the seat belt storage control and for driving the operation device according to the driving signal so as to inform the vehicle occupant of the termination of the seat belt storage control, thereby conducting the seat belt storage winding action without making the vehicle occupant feel uncomfortable.

It is to be understood that both the foregoing general description and the following detailed description are exemplary and explanatory only, and are not restrictive of the invention as claimed.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is a schematic view showing the structure of a seat belt apparatus according to an embodiment of the present invention.

FIG. 2 is a schematic view showing the seat belt retractor shown in FIG. 1.

FIG. 3 is a flow chart for the “seat belt storage control process” according to an embodiment of the present invention.

FIG. 4 is a time chart of the seat belt storage winding action during the “seat belt storage control process” according to an embodiment of the present invention.

### DETAILED DESCRIPTION

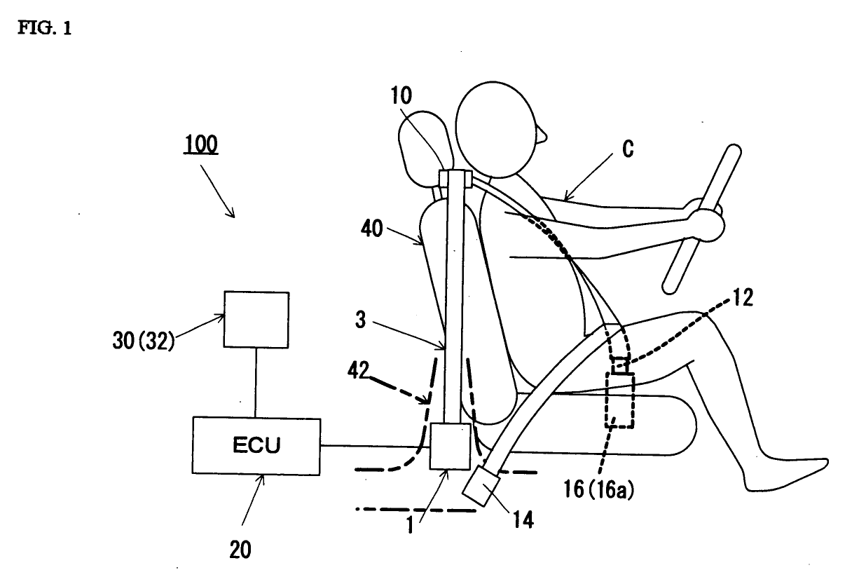

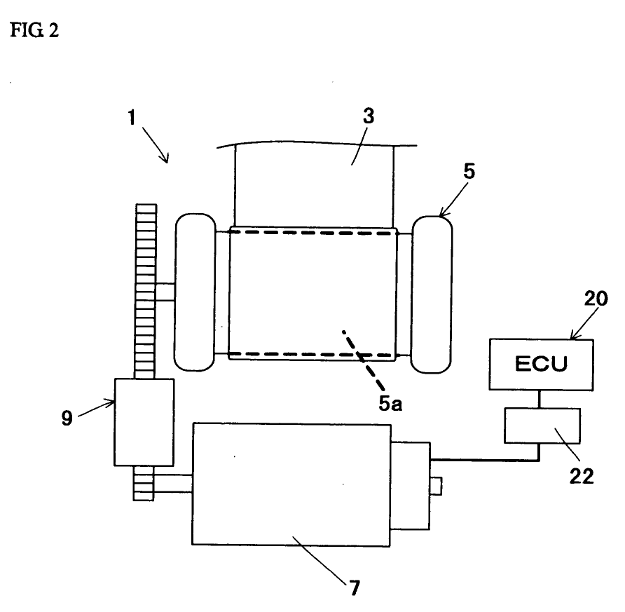

Hereinafter, exemplary embodiments will be described in detail with reference to drawings. First, description will be made as to a seat belt apparatus 100 with reference to FIG. 1 and FIG. 2. FIG. 1 is an illustration schematically showing the structure of the seat belt apparatus 100 according to an embodiment of the present invention. FIG. 2 is an illustration showing the schematic structure of the seat belt retractor 1 shown in FIG. 1.

As shown in FIG. 1, the seat belt apparatus 100 may be a seat belt apparatus for a vehicle, which is installed in an automotive vehicle, and may mainly comprise a seat belt retractor 1, a seat belt 3, a deflection fitting 10, a tongue 12, an outer anchor 14, a seat belt buckle 16, and an ECU 20. In addition, an input element 30 may be installed in the vehicle to detect information about a collision prediction or a collision occurrence of the vehicle, information about the driving state of the vehicle, information about the sitting position and the body size of a vehicle occupant seated in a seat, information about traffic conditions around the vehicle, information about weather conditions and about the time zone, and the like, and to input such detected information to the ECU 20. The detected information of the input element 30 may be transmitted to the ECU 20 anytime or at predetermined intervals and may be used for the operation control of the seat belt apparatus 100 and the like.

The input element 30 may include a collision information detection sensor 32 for detecting information about a vehicle collision such as a prediction of a vehicle collision and an occurrence of an actual vehicle collision. The collision information detection sensor 32 is a sensor capable of detecting (or measuring) information about the distance, the speed, and the acceleration of a collision object (for example, another vehicle, an obstacle, a pedestrian, or the like) relative to the subject vehicle and also detecting (or measuring) the accelerations in the three-axial directions (X-axis, Y-axis, and Z-axis) acting on the subject vehicle. The collision information detection sensor 32 may be composed of a single detection sensor or a combination of a plurality of detection sensors. The collision information detection sensor 32 may be a millimeter wave radar, a laser radar, an acceleration sensor, and/or a camera sensor.

A vehicle door sensor (not shown) may be also mounted to detect the opening/closing state of a vehicle door, that is, to detect whether the vehicle door is in the open state or the closed state. The information detected by the vehicle door sensor may be transmitted to the ECU 20.

The seat belt 3 may be a long belt to be used for restraining a vehicle occupant C (for example a driver) seated in a vehicle seat 40 such as a driver seat. The seat belt 3 may be withdrawn from the seat belt retractor 1 fixed relative to the vehicle, may extend through a deflection fitting 10 provided around an area about the shoulder of the vehicle occupant C, and may be connected to an outer anchor 14 through a tongue 12. The deflection fitting 10 has a function of holding the seat belt 3 to the area about the shoulder of the occupant C and guiding the seat belt 3. By inserting the tongue 12 to a seat belt buckle 16 fixed to the vehicle body, the seat belt 3 goes into the state of being worn by the vehicle occupant C.

The seat belt buckle 16 may have a built-in buckle switch 16a. The buckle switch 16a may be adapted to detect that status of the tongue 12 inserted into the seat belt buckle 16. The information detected by the buckle switch 16a may be transmitted to the ECU 20 which determines whether the seat belt 3 is in the worn state or in the wearing-cancelled state. Specifically, when the buckle switch 16a detects the buckle ON operation, the ECU 20 determines that the seat belt 3 goes into the worn state. On the other hand, when the buckle switch 16a detects the buckle OFF operation, the ECU 20 determines that the seat belt 3 goes into the wearing-cancelled state.

The seat belt retractor 1 may be a device capable of performing the action of winding or unwinding the seat belt 3 via a spool 5 and a motor 7 as will be described later. The seat belt retractor 1 may be installed in an accommodating space in a B-pillar 42 of the vehicle as shown in the embodiment of FIG. 1. The seat belt retractor may be installed in another accommodating space, for example, in a vehicle seat, a side roof rail, and the like.

The ECU 20 may have a function of performing the control of the seat belt retractor 1 and other operational mechanisms based on the input signals from the input element 30. The ECU 20 may comprise a CPU (Central Processing Unit), an input/output unit, a storage unit, a peripheral unit, and the like. The ECU 20 may control the motor 7 of the seat belt retractor 1, as will be described later. Specifically, the ECU 20 may control the voltage level, the amount of current supplied to an electromagnetic coil of the motor 7, and the direction of the current supply so as to vary the rotational speed, the rotational direction, the rotational period of time, and the rotational torque (or output) of a shaft of the motor 7. The ECU 20 may be structured as a means for controlling the driving of the motor 7 and also as a means for controlling a power transmission mechanism 9, as will be described later, so as to switch between the state where the power of the motor 7 is transmitted to the spool 5 and the state where the power is not transmitted to the spool 5. The ECU 20 may be exclusive to the seat belt retractor 1 or it may be used also as the controller for other systems, for example the driving system and/or electric system.

As shown in FIG. 2, the seat belt retractor 1 may mainly comprise the spool 5, the motor 7, and the power transmission mechanism 9. The ECU 20 may also be a component of the seat belt retractor 1.

The spool 5 is formed in a columnar or cylindrical shape of which the outer periphery (or the seat belt contact face) functions as the wind-up surface on which the seat belt 3 is wound. The spool 5 performs the action of winding the seat belt 3 onto the wind-up surface 5a by rotating in the seat belt winding direction and also performs the action of unwinding the seat belt 3 from the wind-up surface 5a by rotating in the seat belt unwinding direction.

The motor 7 may be structured as an electric motor and may be adapted to transmit power to the spool 5 through the power transmission mechanism 9. The motor 7 rotates in such a direction that the spool 5 performs the action of winding the seat belt 3 when the motor is controlled to rotate in the seat belt winding direction. Conversely, the motor 7 may rotate in such a direction that the spool 5 performs the action of unwinding the seat belt 3 when the motor is controlled to rotate in the seat belt unwinding direction. The seat belt retractor 1 may also be provided with a motor current detector 22 for detecting the current value of the motor 7. Information about the current value detected by the motor current detector 22 may be transmitted to the ECU 20 and may be used for the determination of the current value during the “seat belt storage control process” as will be described later.

The power transmission mechanism 9 may be arranged between the spool 5 and the motor 7 and may be structured as a mechanism capable of taking a connected state where the spool 5 and the motor 7 are connected (the power transmission operation mode) and a disconnected state where the connected state is cancelled (the power transmission disconnection mode). The power transmission mechanism 9 may sometimes be referred to as a so-called “clutch” which comprises a combination of gears. The connected state of the power transmission mechanism 9 is a state where the power of the motor 7 is allowed to be transmitted to the spool via the power transmission mechanism 9. When the motor 7 is controlled to rotate in this connected state, the power of the motor 7 is transmitted to the spool 5 via the power transmission mechanism 9. During the connected state, the rotational speed of the motor 7 is reduced by the power transmission mechanism 9. On the other hand, in the disconnected state of the power transmission mechanism 9, the physical connection between the spool 5 and the motor 7 is cancelled so as to allow the easy unwinding (or withdrawing) of the seat belt 3 from the spool 5 manually. Alternatively, the spool 5 and the motor 7 may be directly connected together without the power transmission mechanism 9 between the spool 5 and the motor 7, if required.

The power transmission mechanism 9 may be constructed as a so-called “single-stage clutch” (not shown). Accordingly, when the motor 7 is controlled to rotate with a predetermined motor output in the power transmission operation mode of the power transmission mechanism 9, the rotation of the motor 7 is transmitted to the spool 5 with the rotational speed being reduced so that the spool 5 is driven to rotate with a predetermined torque at a predetermined rotational speed. Instead of the power transmission mechanism 9, a power transmission mechanism capable of changing the rotational torque and the rotational speed of the spool into several stages may be employed. For example, in case of a two-stage clutch capable of changing the rotational torque and the rotational speed of the spool into two stages, the power transmission mechanism may be set in a high-reduction ratio mode with a relatively high rotational torque and a relatively low rotational speed in order to respond to a need for the winding of the seat belt onto the spool with a large belt tension. On the other hand, the power transmission mechanism may be set in a low-reduction ratio mode with a relatively low rotational torque and a relatively high rotational speed in order to respond to a need for the rapid winding of the seat belt onto the spool.

The seat belt retractor 1 according to an embodiment of the present invention may have the following seven seat belt control modes relating to the state of the seat belt 3. Based on these seat belt control modes, the control of the motor 7 and the power transmission mechanism 9 may be performed by the ECU 20. Another seat belt control mode may be added to these seat belt control modes.

(1) Belt Storage Mode

The belt storage mode is a control mode in which the seat belt 3 is not used and fully wound onto the spool 5. In the seat belt retractor 1 in the belt storage mode, the motor 7 is not activated and the power transmission mechanism 9 is set to the power transmission disconnection mode. Therefore, only a very weak belt tension is applied to the seat belt 3 and the power consumption is zero.

(2) Belt Withdrawing Mode

The belt withdrawing mode is a control mode in which the seat belt 3 is withdrawn from the spool 5 so as to be worn by the occupant. The seat belt retractor 1 in the belt withdrawing mode is also set in the power transmission disconnection mode. Therefore, the seat belt 3 may be withdrawn manually with a small force. Also in this case, the motor 7 is not activated so that the power consumption is zero.

(3) Belt Winding and Fitting Mode

The belt winding and fitting mode is a control mode in which after the seat belt 3 is withdrawn and the tongue is inserted into and latched with the seat belt buckle to turn ON the buckle switch, the excessively withdrawn part of the seat belt 3 is wound in order to fit the seat belt 3 to the occupant. Also, the belt winding and fitting mode is a control mode in which when the occupant moves so as to withdraw a predetermined amount of the seat belt 3 from the normally used state of the seat belt 3 (at this point, the buckle switch is in the ON state) and then the occupant returns to the original position, the excess withdrawn part of the seat belt 3 is wound. In the seat belt retractor 1 in the belt winding and fitting mode, the power transmission mechanism 9 is set to the power transmission operation mode and the motor 7 is controlled to rotate at a high rotational speed in the belt winding direction. Therefore, the seat belt 3 is rapidly wound onto the spool 5, and then the motor 7 is stopped when a very small predetermined belt tension is generated, whereby the seat belt 3 is worn by and fitted to the occupant.

(4) Normal Wearing Mode (Comfortable Mode)

The normal wearing mode (also called the comfortable mode) is a control mode in which the occupant wears the seat belt 3 in the normal state after the belt winding and fitting mode is terminated. In the seat belt retractor 1 in the normal wearing mode, the motor 7 is not activated and the power transmission mechanism 9 is set in the power transmission disconnection mode. Therefore, only a very weak belt tension is applied to the seat belt 3 so that the vehicle occupant may wear the seat belt 3 without any stress. In addition, the power consumption is zero.

(5) Warning Mode

The warning mode is a control mode in which when the system detects the driver dozing during operation or detects an obstacle around the vehicle when the vehicle is running and the seat belt is in the normal wearing mode, the seat belt 3 is wound repeatedly a predetermined number of times so as to warn the driver. In the seat belt retractor 1 in the warning mode, the motor 7 is controlled to be alternately activated and stopped several times. Therefore, the operation of applying a relatively strong belt tension (which is weaker than that of the belt tension during the emergency mode as will be described later) and a very weak belt tension onto the seat belt 3 is alternately repeated, thereby drawing the driver's attention to the driver's dozing or the obstacle around the vehicle.

(6) Emergency Mode

Emergency mode is a control mode which is set when the vehicle is extremely likely to have a collision with an obstacle or the like during operation in the normal wearing mode or following the warning mode. In the seat belt retractor 1 in the emergency mode, the power transmission mechanism 9 is set in the power transmission operation mode and the motor 7 is controlled to rotate at a high rotational speed with a high rotational torque in the belt winding direction. Therefore, the motor 7 is stopped when a predetermined extremely strong belt tension is generated on the seat belt 3 after the seat belt 3 is rapidly wound onto the spool 5, thereby securely restraining the vehicle occupant with the seat belt 3.

(7) Belt Winding and Storing Mode

The belt winding and storing mode is a control mode in which the seat belt 3 is fully wound to be in the storage state. In the seat belt retractor 1 in the belt winding and storing mode, the power transmission mechanism 9 is set to the power transmission operation mode and the motor 7 is controlled to rotate in the belt winding direction so as to wind up the seat belt onto the spool 5. Consequently, the action of rapidly winding up the withdrawn seat belt 3 onto the spool 5, i.e., “the seat belt storage winding action,” is conducted, thereby preventing the seat belt 3 from being kept in the unwound state from the spool 5. Thus, the motor 7 is stopped when the seat belt 3 is fully wound and a predetermined belt tension which is very weak is developed, whereby the seat belt 3 goes into the belt storage mode in which the very weak belt tension is applied to the seat belt 3.

With regard to the belt winding and storing mode, the seat belt 3 may be caught on the vehicle occupant or the vehicle seat or the seat belt 3 may be withdrawn by the vehicle occupant when the belt storage winding mode is conducted. For these situations, this embodiment is adapted to repeat the control of stopping the seat belt storage winding action for a predetermined time period from when the seat belt load is increased during the seat belt storage winding action to when the factor increasing the load is eliminated and, after that, restarting the seat belt storage winding action. That is, when the seat belt load is increased during the seat belt storage winding action, an interval is provided for stopping the seat belt storage winding action for a predetermined time period. The increase in seat belt load is determined by the ECU 20 based on the current value of the motor 7 detected by the motor current detector 22 shown in FIG. 2. Specifically, when the current value of the motor 7 exceeds a reference value during the seat belt storage winding action, it is determined that the seat belt 3 is caught on the vehicle occupant or the vehicle seat or that the seat belt is withdrawn by the vehicle occupant, that is, in the “increased load state.”

Also, the maximum number of times that seat belt winding action is repeated may be set to three (i.e., the maximum number of stoppages is three). Accordingly, when the number of times that the seat belt load reaches the predetermined load is between one and three, the seat belt winding action is carried out the corresponding number of times. When the third seat belt winding action is carried out, the seat belt storage control itself is terminated. It should be understood that when the seat belt load does not reach the predetermined load even once, only the first seat belt winding action is carried out and the seat belt storage control is terminated upon completion. When the motor 7 is driven and the seat belt load acting on the seat belt 3 reaches to the predetermined load in the belt winding and storing mode, the driving of the motor 7 is temporarily stopped. After such control is conducted once or several times, the seat belt storage control is terminated.

However, the seat belt storage control may cause the incomplete storage of the seat belt even after the action of temporarily stopping the seat belt winding action or the driving of the motor 7 is repeated the maximum number of times (such as three times). In this case, a vehicle occupant who notices that the storage of the seat belt is incomplete can hardly judge whether the cause of this phenomenon is the termination of the seat belt storage control or a failure of the seat belt apparatus. Thus, the vehicle occupant is made to feel uncomfortable and/or uneasy.

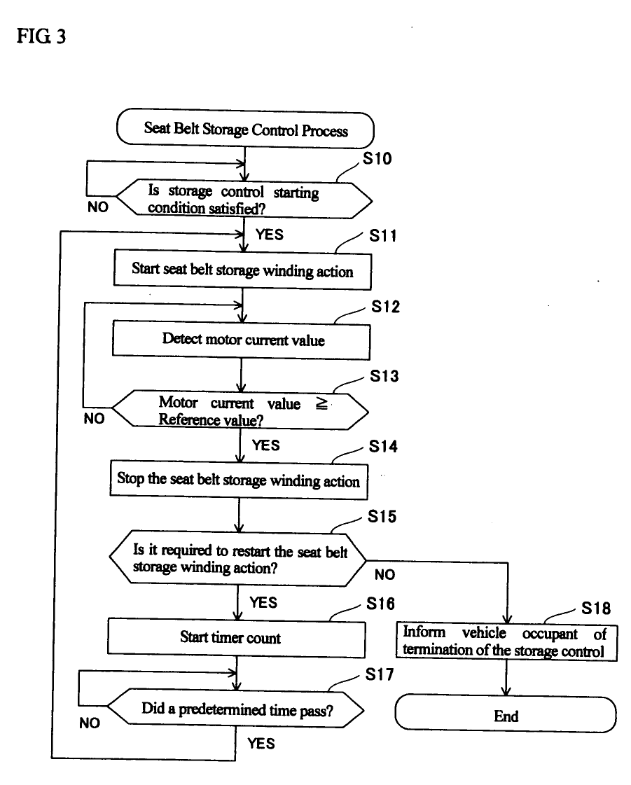

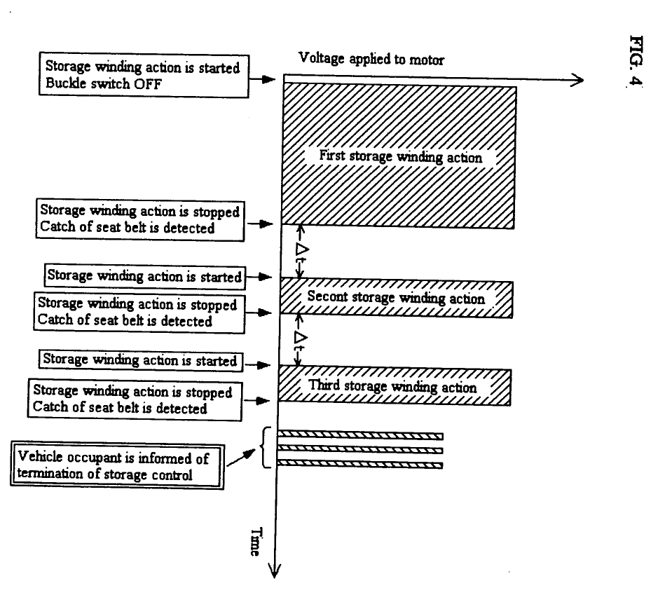

To address the uncomfortable feeling or uneasiness, an informing control for informing the vehicle occupant of the termination of the seat belt storage control (sometimes, called simply “the storage control”) when the seat belt storage control is terminated. Specifically, when the seat belt load is increased during the seat belt storage control, the seat belt storage winding action is temporarily stopped. In addition, when the seat belt storage control is terminated, the vehicle occupant is informed of the termination of the seat belt storage control by an action of the winding up the seat belt 3. Hereinafter, this embodiment will be described in more detail with reference to FIG. 3 and FIG. 4.

FIG. 3 is a flow chart for the “seat belt storage control process” according to an embodiment of the present invention and FIG. 4 is a time chart of the seat belt storage winding action during the “seat belt storage control process.”

In the seat belt storage control process as shown in FIG. 3, in step S10, it is determined whether or not a storage control starting condition is satisfied, specifically, when the release or insertion of the tongue 12 relative to the seat belt buckle 16 shown in FIG. 1 is detected by the buckle switch 16a. That is, when the seat belt 3 is changed from the worn state to the released state relative to the vehicle occupant, it is determined that the storage control starting condition is satisfied. This determination may be achieved by the ECU 20 which detects the information from the buckle switch 16a. The determination of whether or not the storage control starting condition is satisfied may be made based on the information about the open/closed state of the vehicle door in addition to the information of the state of the seat belt buckle. In step S10, the process continues until the seat belt buckle is changed from the ON state to the OFF state and proceeds to step S11 where it is determined that the seat belt buckle is changed from the ON state to the OFF state (the “YES” path from step S10).

In step S11, the power transmission mechanism 9 of the seat belt retractor 1 is set to the power transmission operation mode and the motor 7 is controlled to rotate the spool 5 to wind up the seat belt (a constant voltage V1 is supplied as shown in FIG. 4), thereby performing the seat belt storage winding action for the first time. The seat belt storage winding action may be conducted only by the driving force of the motor 7 or by the winding force of an elastic member such as a return spring acting on the spool 5 with the driving force of the motor 7 used as secondary force.

In step S12, the motor current detector 22 detects the current value of the motor during the seat belt storage winding action. In step S13, it is determined whether or not the detected current value exceeds the reference current value. The processes of step S12 and step S13 continue until the detected current value exceeds the reference current value. When the current value of the motor exceeds the reference current value (the “YES” path from step S13), it is determined that the seat belt load is increased so that the process proceeds to step S14. In step S14, the seat belt storage winding action is temporarily stopped. The factor increasing the seat belt load may be the seat belt 3 being caught on the vehicle occupant or the vehicle seat 40 or the vehicle occupant withdrawing the seat belt.

In step S15, it is determined whether or not it is required to restart the seat belt storage winding action for a second time. When it is determined that it is required to restart the seat belt storage winding action (the “YES” path from step S15), the process proceeds to step S16 and step S17 where it is determined whether or not the stopping time period of the seat belt storage winding action reaches a predetermined time period (the stopping interval Δt shown in FIG. 4). When the stopping time period of the seat belt storage winding action reaches the predetermined time period (the “YES” path in step S17), the process returns to step S11 to restart the seat belt storage winding action for a second time until step S14, similar to the first seat belt storage winding action. The seat belt storage winding action from step S11 to step S14 is repeated based on the predetermined maximum repeating number of times. In the time chart shown in FIG. 4, the maximum repeating number of times is three so that the time chart shows a case that the seat belt storage winding action is repeated three times in total.

On the other hand, when it is determined that it is required to finish the seat belt storage winding action (the “NO” path from step S15), that is, when it is required to terminate the seat belt storage control, the process proceeds to step S18 informing the vehicle occupant of the termination of the storage control. The notification of the termination of the storage control may be conducted by the winding action of the seat belt 3. Specifically, the motor 7 is controlled to wind up the seat belt 3 differently from the seat belt storage winding action in the storage control, for example, in such a form as to wind up or pull the seat belt 3 intermittently by intermittently supplying a voltage V2 as shown in FIG. 4. In this case, the motor 7 is a means which is activated based on an activation signal from the ECU 20 and thus winds up the seat belt 3 in such a manner as to inform the vehicle occupant of the termination of the seat belt storage control.

It is preferable that the voltage and current to be supplied to the motor is controlled to perform the winding action of the seat belt 3 for notification so as to allow the vehicle occupant to distinguish the winding action for notification from the normal seat belt storage winding action so as to not make the vehicle occupant feel uncomfortable.

As mentioned above, the vehicle occupant is informed or notified that the storage control itself is terminated by the winding action of the seat belt regardless of whether the storage is complete (i.e., the seat belt 3 is fully wound onto the spool 5) or incomplete (i.e., the seat belt 3 is not fully wound onto the spool 5). Accordingly, even when the motor 7 is stopped before the seat belt 3 is fully wound onto the spool 5, the vehicle occupant notices that the cause is the termination of the storage control and not a failure of the seat belt apparatus. Therefore, the storage control may be conducted without making the vehicle occupant feel uncomfortable and/or uneasy.

The winding action of the seat belt 3 may be used for informing the vehicle occupant of the termination of the storage control, thereby rationalizing the action of the seat belt retractor 1 and the seat belt apparatus 100.

Also, there is no need to employ a detection sensor to detect how much the seat belt 3 is stored, thereby keeping the costs of the seat belt retractor 1 and the seat belt apparatus 100 low.

Therefore, a seat belt retractor 1, a seat belt apparatus 100, and a vehicle with the seat belt apparatus 100 is provided capable of conducting the seat belt storage control of a seat belt 3 by using a motor 7 without making the vehicle occupant feel uncomfortable and/or uneasy.

The present invention is not limited to the aforementioned exemplary embodiments, and various variations and modifications may be made. For example, the following additional exemplary embodiments as variations of the aforementioned embodiments may be carried out.

Though the above exemplary embodiments have been described with regard to a case that the winding action of the seat belt 3 driven by the motor 7 is used as the means for informing the vehicle occupant of the termination of the seat belt storage control, the present invention may employ other arrangements. For example, the means for informing the vehicle occupant of the termination of the seat belt storage control may employ a device having an audio output function outputting a voice, a buzz or the like; a device having an indication function outputting characters, figures, images or the like; a device for impressing the vehicle occupant with the operation of a movable member other than the seat belt 3; a device having a function of applying pressure, drawing force, causing vibration or the like to the vehicle occupant; or a combination of two or more of the above devices.

The timing of informing the vehicle occupant of the termination of the seat belt storage control may be after the termination of the final seat belt winding action, during the final seat belt winding action, or just before the final seat belt winding action.

Though the above exemplary embodiment has been described with regard to a case that the notification of the termination of the seat belt storage control is conducted by controlling the motor 7 to intermittently wind up the seat belt 3, the present invention may employ another form for winding up the seat belt other than the intermittent winding. For example, the ability to conduct the seat belt winding action differently from the normal seat belt storage winding action may be used to inform the vehicle occupant of the termination of the seat belt storage control. In one example, the motor 7 is controlled to conduct the seat belt winding action for notification at a winding speed or winding acceleration which is different from that of the normal seat belt storage winding action.

Though the above exemplary embodiments have been described with regard to the seat belt apparatus 100 for the vehicle occupant seated in the driver's seat, the present invention may be adapted to seat belt apparatuses for vehicle occupants seated in vehicle seats other than the driver seat, such as a front passenger seat and a rear seat located behind the driver seat and the front passenger seat.

Though the above exemplary embodiments have been described with regard to the seat belt retractor 1 and the seat belt apparatus 100 to be installed in an automobile, the embodiments of the seat belt retractor may be adapted to seat belt retractors and seat belt apparatuses to be installed in vehicles for transport of vehicle occupants such as an automobile, an aircraft, a boat, a train, and a bus.

The priority application, Japanese Patent Application No. 2005-338776, filed on Nov. 24, 2005, is incorporated herein by reference in their entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seat belt retractor to be installed in a vehicle comprising:
an electric motor;
a spool for winding a seat belt for occupant restraint in association with driving of the electric motor; and
a controller for controlling the driving of the electric motor,
wherein the controller is configured to conduct an operating control so as to activate the electric motor to rotate the spool to wind up the seat belt when a condition for starting a seat belt storage control is satisfied, and to temporarily stop the driving of the electric motor in cases where seat belt load acting on the seat belt reaches a predetermined load during the driving of the electric motor,
wherein, after the operating control is conducted once or a plurality of times, the controller is configured to terminate the seat belt storage control and to output a driving signal to an operation device at the termination of the seat belt storage control to activate the operation device to inform the vehicle occupant of the termination of the seat belt storage control.

2. The seat belt retractor as claimed in claim 1, further comprising the operation device comprising the electric motor, the spool, and the seat belt.

3. The seat belt retractor as claimed in claim 2, wherein the controller is configured to output a control signal for an operation mode different from that for the seat belt storage control to the electric motor to inform the vehicle occupant of the termination of the seat belt storage control by an action of winding the seat belt onto the spool according to the control signal.

4. A seat belt apparatus to be installed in a vehicle comprising:
a seat belt for occupant restraint which may be worn by a vehicle occupant;
an electric motor;
a spool for winding the seat belt in association with driving of the electric motor;
a controller for controlling the driving of the electric motor; and
an operation device,
wherein the controller is configured to determine that, when cancellation of a wearing of the seat belt relative to the vehicle occupant is detected, a condition for starting a seat belt storage control is satisfied and activates the electric motor to rotate the spool to wind up the seat belt,
wherein the controller is configured to conduct an operating control as to temporarily stop the driving of the electric motor when a current value of the electric motor reaches a predetermined reference value during the driving of the electric motor,
wherein, after the operating control is conducted once or a plurality of times, the controller is configured to terminate the seat belt storage control and to output a driving signal to the operation device at the termination of the seat belt storage control, and
wherein the operation device is configured to be activated according to the driving signal from the controller for informing the vehicle occupant of the termination of the seat belt storage control.

5. The seat belt apparatus as claimed in claim 4, further comprising:
a seat belt buckle configured to be fixed to the vehicle; and
a tongue attached to the seat belt and is configured to latched to the seat belt buckle when the seat belt is worn.

6. The seat belt apparatus as claimed in claim 5, further comprising a buckle detection sensor for detecting that the tongue is latched to the seat belt buckle,
wherein the controller is configured to determine the cancellation of the wearing of the seat belt relative to the vehicle occupant based on information detected by the buckle detection sensor.

7. The seat belt apparatus as claimed in claim 4, further comprising a current detection sensor for detecting a current value of the electric motor,
wherein the controller is configured to determine the current value of the electric motor based on information detected by the current detection sensor.

8. The seat belt apparatus as claimed in claim 4, wherein the operation device comprises the electric motor, the spool, and the seat belt.

9. The seat belt apparatus as claimed in claim 8, wherein the controller is configured to output a control signal for an operation mode different from that for the seat belt storage control to the electric motor to inform the vehicle occupant of the termination of the seat belt storage control by action of winding the seat belt onto the spool according to the control signal.

10. A vehicle with a seat belt apparatus comprising:
a seat belt apparatus comprising:
a seat belt for occupant restraint which may be worn by a vehicle occupant;
an electric motor;
a spool for winding the seat belt in association with driving of the electric motor;
a controller for controlling the driving of the electric motor; and
an operation device,
wherein the controller is configured to determine that, when cancellation of a wearing of the seat belt relative to the vehicle occupant is detected, a condition for starting a seat belt storage control is satisfied and activates the electric motor to rotate the spool to wind up the seat belt,
wherein the controller is configured to conduct an operating control as to temporarily stop the driving of the electric motor when a current value of the electric motor reaches a predetermined reference value during the driving of the electric motor,
wherein, after the operating control is conducted once or a plurality of times, the controller is configured to terminate the seat belt storage control and to output a driving signal to the operation device at the termination of the seat belt storage control, and
wherein the operation device is activated according to the driving signal from the controller for informing the vehicle occupant of the termination of the seat belt storage control.

11. The vehicle as claimed in claim 10, further comprising a vehicle seat, and
wherein the seat belt apparatus further comprises:
a seat belt buckle fixed to the vehicle; and
a tongue attached to the seat belt and is configured to latched to the seat belt buckle when the seat belt is worn.

12. The vehicle as claimed in claim 11, wherein the controller is adapted to detect the cancellation of the wearing of the seat belt when the tongue latched to the seat belt buckle is released from the seat belt buckle by the vehicle occupant seated in the vehicle seat.

13. The vehicle as claimed in claim 11, further comprising a buckle detection sensor for detecting that the tongue is latched to the seat belt buckle, and
wherein the controller is configured to determine the cancellation of the wearing of the seat belt relative to the vehicle occupant based on information detected by the buckle detection sensor.

14. The vehicle as claimed in claim 10, further comprising a current detection sensor for detecting a current value of the electric motor, and
wherein the controller is configured to determine the current value of the electric motor based on information detected by the current detection sensor.

15. The vehicle as claimed in claim 10, wherein at least part of the seat belt apparatus is accommodated in an accommodating space in the vehicle.

16. The vehicle as claimed in claim 15, wherein the accommodating space is an accommodating space in a pillar or an accommodating space in a vehicle seat.
